(19) United States
(12) Patent Application Publication
(10) Pub. No.: US 2007/0272621 A1
(43) Pub. Date: Nov. 29, 2007

(54) Pulsed power water treatment

(75) Inventor: John Edward Dresty JR., South Glastonbury, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Clearwater Systems Corporation, Essex, CT (US)

(21) Appl. No.: 11/801,493

(22) Filed: May 9, 2007

Related U.S. Application Data
(60) Provisional application No. 60/799,162, filed on May 9, 2006.

(51) Int. Cl. C02F 1/32

(52) U.S. Cl. 210/748

(57) ABSTRACT

Water in a recirculating hot potable water system 110 is treated by power pulses, by placing a coil 18 near the water and providing to the coil 18 an AC power source 12. The power source 12 is connected in a first loop with the coil 18 and a switch 20 during at least a portion of a first half-cycle of the AC power source period. The switch 20 is opened during a second half-cycle, during which a subroutine of producing at least a first ringing pulse in the coil assembly is performed. Preferably, the water is treated chemically as well by the power pulses. An improved water system has a water heater 112 and a circulation line 116 providing a flow loop. There is a tap 124 for diverting circulating water through an external loop and there is a pulsed power water treatment apparatus 122 mounted on the circulation line. A chemical treatment apparatus 126 is periodically connected to the tap.

### CROSS-REFERENCE TO RELATED APPLICATION

This application claims the benefit of U.S. provisional application No. 60/799,162, filed May 9, 2006, which is hereby incorporated herein by reference, in its entirety.

### FIELD OF THE INVENTION

This invention relates to water purification, and in particular, to the use of electromagnetic pulses for ameliorating bacteria in water.

### BACKGROUND

Legionellosis or Legionnaires' disease is a form of pneumonia brought about by the inhalation of bacteria from one or more species of the genius Legionella. Although not common in terms of total numbers of cases, Legionnaires' disease often occurs as outbreaks of numerous cases resulting in multiple fatalities. As such, Legionnaires' disease has attracted significant attention from scientific organizations, such as the US Center for Disease Control and the World Health Organization, as well as the health care community.

Legionnaires' disease results from the inhalation of Legionella bacteria. Other routes of exposure such as ingestion do not result in illness. The number or concentration of Legionella bacteria necessary to cause infection is not known. The susceptibility to infection varies widely between individuals. Young, elderly, and immune-compromised individuals are substantially more susceptible than the general population.

Legionella bacteria are present at low levels in nearly all natural waters. At temperatures below approximately 70° F., the bacteria multiply very slowly and are not considered a significant potential source of infection. At temperatures above about 140° F. Legionella bacteria also multiply slowly, which reduces the risk of infection. Thermal elimination of the risk of infection requires temperatures of approximately 160° F. Between approximately 70° F. and 140° F., Legionella bacteria interact with biofilm that is present on most wetted surfaces and amoeba which are commonly found in the biofilm. Through a process known as amplification, Legionella bacteria multiply rapidly and may become more virulent than in the non-amplified condition. When these water and temperature conditions are associated with devices which produce mists or respirable droplets and within the breathing zones of immune compromised individuals, a significant risk of infection exists.

Outbreaks of Legionnaires' disease have been traced to a wide variety of sources. Potentially the most significant source is hospital showers. In this situation Legionella containing respirable water droplets are sprayed directly into the breathing zones of individuals whose health is less than optimal. The presence of Legionella bacteria in the shower is attributable to the presence of small levels of Legionella bacteria in the cold potable water system and to the design of hospital hot water systems.

Legionella bacteria are resistant to chlorine and chlorine compounds at levels typically used in drinking water systems. This resistance permits a few bacteria to reach the hot water system of a hospital or any other type of building. In hospitals, and many other large buildings, the hot water systems are designed as loops in which hot water is continually circulated. This design minimizes the amount of water which stands in the piping system and guarantees that a user of hot water will never have to wait more than a few seconds for the water to heat up. In order to prevent scalding, many building codes limit the temperature of the circulating water. While the temperature limits vary with location, they are almost always within the temperature range for Legionella growth and amplification.

In addition to being favorable for the growth of Legionella bacteria, the circulating water temperatures are also favorable for the growth of other bacteria and higher forms of microscopic life such as amoeba. The growth of these life forms in the hot water system leads to the formation of a biofilm on the pipe walls. Typical levels of chlorination in the hot water system are not sufficient to kill the biofilm. Proper temperatures and ineffective biocidal control permit Legionella bacteria to thrive in the hot water circulating loop and permit its spread to the non circulating portions of the system, e.g., faucets, showers, and system dead legs (portions of the piping system which are used irregularly or not at all).

A wide variety of approaches have been tried to resolve this problem including super chlorination, increasing the temperature of the circulating water, chlorine dioxide treatment, and the use of copper silver electrodes. All of these treatment methods are somewhat effective in addressing the Legionella bacteria problem but all have one or more significant shortcomings in effectiveness, safety, reliability, or economics. In particular, installing and operating chlorine dioxide treatment equipment on a full-time basis is very expensive. Alternative treatment technologies exist, but they are also expensive and may be less effective than chlorine dioxide treatment.

Pulsed power technology for the purpose of bacterial control in food was developed by Maxwell laboratories, disclosed in U.S. Pat. No. 4,524,079 (which is hereby incorporated herein in its entirety) and commercialized by PurePulse of San Diego Calif. This technology is approved by the United States Food and Drug Administration and is used for the cold pasteurization of foods. This technology field was further developed by Clearwater Systems Corporation, the assignee of this patent, as disclosed in U.S. Pat. No. 6,063,267, which is hereby incorporated herein in its entirety. This technology has been commercialized by Clearwater Systems of Essex Conn. under the trade name Dolphin. It has been successfully used to control bacterial life and the formation of calcium carbonate scale in flowing water systems for non-consumptive use, most notably air conditioning cooling towers.

Chemical treatment of water, e.g., treatment with chlorine dioxide, is known to be effective to quickly kill biofilm and various bacteria, including Legionella bacteria. Chlorine dioxide has been effectively used for Legionella control when applied continuously in some instances, but suffers from economic, maintenance, and safety issues.

The purification of water in potable water systems is more difficult than in non-potable water systems due to the constraints placed on the water system for the protection of the users of the water. For example, it is often impermissible to heat water in potable hot water systems to an anti-bacterial temperature (e.g., above 120° F., preferably about 160° F. or higher), because water at such temperatures can injure uses. Accordingly, the temperature of water in such systems is often limited to about 120° F. or less, optionally about 110° F. or less, at which temperatures many injurious bacteria become amplified, rather than die. For this reason, potable hot water systems are often treated with chemical anti-bacterial treatments that do not affect the potability of the water.

Based on the foregoing, it is the general object of this invention to provide a method and apparatus that improves upon, or overcomes the problems and drawbacks of prior art purification systems, especially for hot water systems that include recirculation units.

### SUMMARY OF THE INVENTION

The present invention resides in one aspect in a method for treating a flow of water in a recirculating hot water system. The method includes subjecting the flow to a combination of electromagnetic pulses and chemical treatment.

In a preferred embodiment, the method includes applying to the water a chemical purification treatment and pulsing electromagnetic pulses, and then applying the pulses without the chemical treatment.

The present invention resides in another aspect in an improved circulating potable hot water system. The system has a water heater and a circulation line providing a flow loop for water to and from the water heater. There is also a tap for diverting circulating water through an external flow loop. The improvement comprises a pulsed power water treatment apparatus mounted on the circulation line.

### BRIEF DESCRIPTION OF THE DRAWINGS

FIG. 1 is a schematic circuit diagram of an apparatus for generating a ringing magnetic pulse for treating flowing liquid in accordance with the invention;

FIG. 2 is an oscilloscope trace showing a single large ringing pulse according to the invention;

FIG. 3 is an oscilloscope trace showing a “natural” ringing pulse followed by more than one large ringing pulse according to the invention;

FIG. 4 is an oscilloscope trace showing a series of six full large ringing pulses according to the invention; and

FIG. 5 is an oscilloscope trace showing a series of ringing pulses initiated without letting prior pulses substantially decay, according to one embodiment of the invention; and

FIG. 6 is a schematic representational view of a recirculating hot water system that includes a pulsing treatment apparatus according to the present invention.

### DETAILED DESCRIPTION OF THE INVENTION

According to this invention, pulsed power technology is utilized to subject water to electromagnetic pulses for the elimination, reduction and/or inhibition of bacteria or other microscopic pathogens, including Legionella bacteria, and for the elimination, reduction and/or inhibition of biofilm, in circulating, hot, potable water systems. Power pulse technology alone will provide excellent biological control, at least regarding water that is flowing in the recirculation loop; lesser results may be obtained in branch lines and dead legs. Accordingly, this invention also comprises the synergistic use of a pulsed power device and at least intermittent chemical treatment for hot, potable water systems.

In one embodiment, the invention is implemented in new or existing recirculating hot water systems by providing a pulsed power device such as that disclosed in U.S. Pat. No. 6,063,267, as improved by Clearwater Systems (hereafter referred to as a “Dolphin pulsed power water treatment apparatus”) in the recirculation loop. The Dolphin pulsed power water treatment apparatus is installed either at the heater outlet or at the heater inlet from the recirculating loop, and by providing a chemical treatment device such as a chlorine dioxide generator. Optionally, the chemical treatment device may be removable and may be connected to the circulation system only when needed. The invention employs the combined continuous use of the pulsed power water treatment apparatus to control biofilm, and thereby Legionella bacteria, with the intermittent use of a chemical treatment, such as chlorine dioxide, to provide quick, hard kills of bacteria and biofilm. Use of the invention will accrue the benefits of improved treatment efficacy, reduced treatment costs, and reduced hazards to maintenance workers as compared to current treatment methods. This invention makes intermittent chemical treatment, and in particular, intermittent chlorine dioxide treatment feasible. Accordingly, it is now useful to provide a portable (e.g., truck or trailer-based) chlorine dioxide water treatment facility that can tap into a recirculating water system on an intermittent basis and, in the interim between treatments, treat water at other facilities. As a result, the overall cost for the substantial elimination of the risk of Legionnaires' disease and other diseases is substantially reduced.

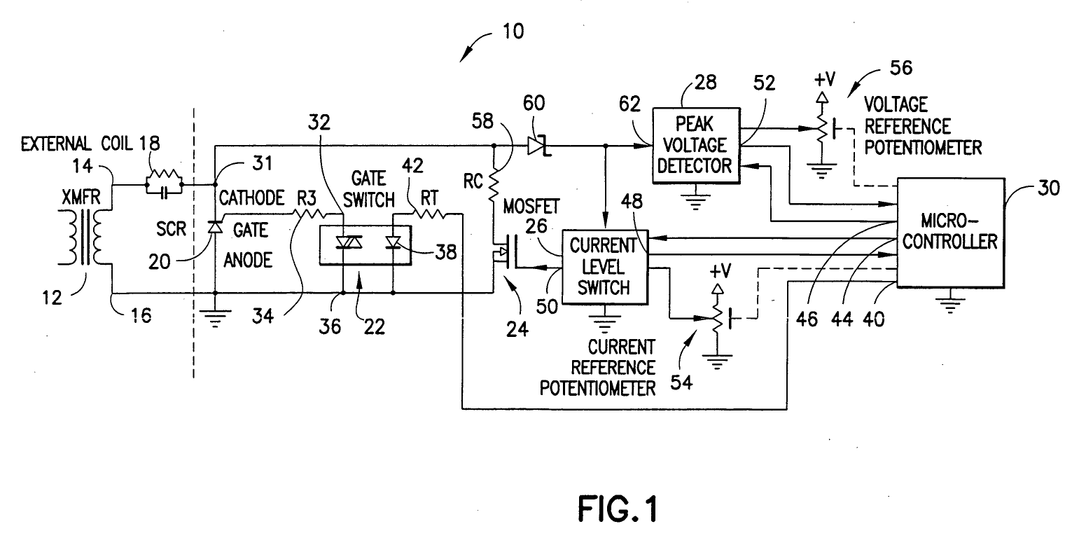

With reference to FIG. 1, a pulsed power apparatus for generating a ringing magnetic pulse for treating flowing liquids in accordance with the present invention is indicated generally by the reference number 10. The apparatus 10 comprises an input power transformer 12 having first and second output terminals 14, 16, a coil assembly 18, an SCR 20, a optical relay 22, a MOSFET 24 serving as an electronically controlled switch, a current level switch 26, a peak voltage detector 28, and a programmable digital microcontroller 30.

It has been discovered that digital control systems for generating a ringing magnetic pulse can be modified in order to be of simpler construction and less expensive by substituting a single silicon controlled rectifier (SCR) switch for a MOSFET switch assembly. SCRs are available with higher current ratings and lower losses relative to MOSFETs, and a single device can easily handle the coil current. However, SCRs cannot be electronically turned off as a MOSFET can, so that the high voltage “ringing” pulse has to be produced some other way than by interrupting the coil current pulse, as will be explained more fully below.

Referring again to FIG. 1, the coil assembly 18, which comprises a coil and is characterized as having an inductance and a capacitance connected in parallel, has a first end coupled to the first terminal 14 of the transformer 12. The illustrated capacitance can be and is herein taken to be comprised solely of the capacitance of the coil, but in some coils the stray capacitance may be supplemented by a discrete capacitor connected in parallel with the coil. The SCR 20 has a cathode coupled to a second end 31 of the coil assembly 18, and an anode coupled to the second output terminal 16 of the transformer 12. As shown, the anode of the SCR 20 is coupled to electrical ground. The optical relay 22 serves as an SCR gate switch. As shown in FIG. 1, the optical relay 22 has a first terminal 32 coupled to the gate of the SCR 20 via a gate resistor 34, and a second terminal 36 coupled to ground potential. The optical relay 22 further includes a light emitting diode (LED) 38 that when energized to emit light closes the gate switch to enable current flow between the first and second terminals 32, 36 of the optical relay 22. Thus, the coil assembly 18 and the SCR 20 form a series connected circuit in parallel to the power transformer 12, making a first loop.

The microcontroller 30 includes a first output 40 coupled to an anode of the LED 38 via a resistor 42, a second output 44 coupled to the current level switch 26, and a third output 46 coupled to the peak voltage detector 28. The current level switch 26 includes a first output 48 coupled to the microcontroller 30, and a second output 50 coupled to the gate of the MOSFET 24. The peak voltage detector 28 includes an output 52 coupled to the microcontroller 30. A digitally controlled current reference potentiometer 54 is coupled to an input of the current level switch 26, and is adjustable by the microcontroller 30. A digitally controlled voltage reference potentiometer 56 is coupled to the peak voltage detector 28, and is adjustable by the microcontroller 30.

The MOSFET 24, such as the illustrated n-channel IGFET with substrate tied to source, includes a source coupled to ground potential, and a drain coupled to the second end 31 of the coil assembly 18 via a current sense resistor 58. A high voltage Schottky diode 60 has an anode coupled to the second end 31 of the coil assembly 18 and a cathode coupled to an input 62 of the peak voltage detector 28.

The apparatus 10 is generally preferably mounted on a printed circuit board (not shown). However, two components are preferably external to the printed circuit board (PCB), namely, the coil assembly 18 and the power transformer 12. The transformer 12 provides a 50-60 Hz AC power to power the coil assembly 18. The main power component on the PCB is the SCR 20 which is preferably heat-sinked and which functions as a controllable diode. When an ordinary diode is forward-biased (anode voltage positive with respect to the cathode) it conducts current. When an SCR is forward-biased it will not conduct current unless the gate (control) lead is also forward-biased. Both an SCR and an ordinary diode will block current if they are reverse-biased.

When the SCR gate lead is connected to its anode (via a resistor), the SCR will conduct current when the SCR anode is positive with respect to its cathode. This occurs during the negative voltage half-cycle (as referenced to the SCR anode which is considered to be circuit ground in FIG. 1). Since the coil assembly 18 is predominantly inductive (with some small internal resistance) at 60 Hz, negative current will continue to flow for a large portion of the positive voltage half-cycle. When the current drops to zero, the SCR 20 will block positive current flow (from cathode to anode) as does a diode rectifier. When the SCR 20 turns off, the voltage across the SCR will jump to a positive level during the remainder of the positive voltage half-cycle. It is during this positive voltage period that the microcontroller 30 generates at least one ringing current and voltage pulse within the coil assembly 18.

A ringing pulse across the coil assembly 18 is created by first closing the MOSFET solid-state switch 24 for a brief period at any time during the positive voltage cycle when the SCR 20 is off. The MOSFET 24 is closed, or made to conduct, by applying a positive voltage to its control electrode or gate via the current level switch 26. Positive current will build up in the coil assembly 18 while the MOSFET 24 is closed (the rise time is determined by the value of the current sense resistor 58 and the inductance of the coil assembly 18). When the current level reaches a designated trigger value, the MOSFET switch 24 is abruptly opened by the current level switch 26 (the current level switch removes the positive voltage from the gate of the MOSFET 24, which causes the MOSFET to become non-conducting). The inductance and capacitance values of the coil assembly 18 will determine the frequency of the resulting resonating current flow within the coil and the magnitude of the ringing voltage as viewed across the SCR 20. The decay time of the ring is determined by the internal resistance of the coil assembly 18.

The gate resistor 34 of the SCR 20 must be disconnected from the anode of the SCR during the positive voltage period to prevent the SCR from turning on when ringing pulses are generated—which would quickly terminate the ring. An optical relay 22 (as shown in FIG. 1) is provided for this purpose. The optical relay 22 need only be energized prior to the start of the negative voltage half-cycle. Once current starts to flow in the SCR 20, the optical relay 22 can be de-energized. The SCR 20 will continue to conduct until current drops to zero and the cathode-to-anode voltage across the SCR is positive. Interestingly, a small ringing pulse in the coil assembly 18 occurs when the SCR 20 switches off which is caused by the charge stored in the coil capacitance.

The operation of the apparatus 10 is primarily implemented using the programmable digital microcontroller 30 coupled to and aided by the peak voltage detector 28 and the current level switch 26. The microcontroller 30 does not directly interface with the coil assembly 18, the SCR 20 and the MOSFET 24; nor does the microcontroller directly view the coil voltage level. The coil voltage is presented to the current level switch 26 and the peak voltage detector 28 through the high voltage Schottky diode 60. The current level switch 26 and the peak voltage detector 28 compare the incoming voltage level to a reference voltage level set by the digitally controlled potentiometers 54, 56, respectively to determine its action.

The primary function of the peak voltage detector 28 is to compare the level of the coil ringing voltage signal to the reference level set by the digital potentiometer 56 associated with the peak voltage detector. If the peak level exceeds the given reference level, the peak voltage detector 28 will store that event so that it can be later read by the microcontroller 30. The stored event is cleared after it is read by the microcontroller 30. The peak voltage detector 28 is used to determine that the peak voltage exceeds the minimum desired value and also that it does not exceed a maximum value. A secondary function of the peak voltage detector 28 is to determine the value of the transformer voltage on start-up. The microcontroller 30 needs to know the transformer voltage because the ring signal rides on top of the transformer voltage. The transformer voltage reading is added to the desired ring voltage level when the reference voltage is set.

The current level switch 26 controls the MOSFET 24 used to generate the coil ringing pulse. The microcontroller 30 sends a trigger pulse to the current level switch 26 to initiate a ring. When triggered, the current level switch 26 raises the voltage on the gate lead of the MOSFET 24, thereby turning it on. The “on” resistance of the MOSFET 24 is much less than the value of the current sense resistor 58. The MOSFET 24 is held “on” until the voltage at the current sense resistor 58—coil junction (the cathode of the SCR 20) exceeds the reference voltage set by the current reference potentiometer 54 associated with the current level switch 26. The value of the resistor 58 and the reference voltage is not as important as ensuring that the current value at which the MOSFET 24 turns off is repeatable for a given potentiometer setting. The role of the microcontroller 30 is to adjust the potentiometer 54 of the current level switch 26 to achieve the desired voltage level for the coil “ring.” Thus, the microcontroller 30, potentiometer 54 and current level switch 26 regulate at least the initial voltage of the ringing current pulse. Optionally, the microcontroller 30, potentiometer 54 and current level switch 26 are adapted to keep the voltage of the ringing current plus between a predetermined minimum value and a predetermined maximum value.

The overall operation of the microcontroller 30 is executed in software embedded within the microcontroller. The functions of that software program are now described. When the apparatus 10 is first powered-up, the SCR 20 and the MOSFET 24 are both off (i.e. no current flows through the coil assembly 18). The first task of the microcontroller 30 is to test for the presence of coil power voltage from the transformer 12. This can be accomplished by setting the peak voltage detector 28 at a low level and monitoring the output. An alternative method is to monitor a tap provided in the current level switch 26 which reads zero when the coil voltage is negative and rises to +0.5V when the coil voltage goes positive. The microcontroller 30 waits until it observes two alternating 50-60 Hz power line voltage cycles before proceeding. When the AC coil voltage is detected, the microcontroller 30 will measure its peak level by monitoring the output of the peak voltage detector 28 while it raises the level of the voltage reference potentiometer 56. The peak level reading is retained in the microcontroller 30 and used as an offset for adjusting the level of the generated ring pulses which ride on the coil power voltage.

The next software task is to turn on the SCR 20, which is a periodic task occurring once per voltage cycle. Since the SCR anode is used as the ground-reference, the SCR anode-to-cathode voltage is negative during the positive voltage portion of the cycle. Just before the end of the positive voltage period, the SCR gate switch or optical relay 22 is turned on by powering its optically coupled LED 38. When the negative voltage across the SCR 20 is approximately 2 volts, the SCR will begin to conduct current, at which time power to the gate switch LED 38 is removed. The SCR 20 will remain latched on without the gate switch 22 being powered, until the SCR 20 current flow drops to zero.

The ringing pulses are produced by a second periodic software task. This task waits until the SCR 20 turns off and a positive coil voltage is detected (which is a sharp jump nearly the height of the peak coil voltage). The task waits a few milliseconds to allow the small coil ring (which occurs when the SCR 20 turns off) to die out. To generate a high voltage ringing pulse the software sends a trigger signal to the current level switch 26, which turns on the MOSFET 24, allowing positive current flow to rise in the coil assembly 18. The task monitors the current level switch 26. When the current level switch signals that the desired amount of current is present in the circuit, the MOSFET is turned off. The rapid cessation of the flow of current in the coil triggers a large coil ring. In one embodiment of this invention, only a single large ringing pulse is created in the second half-cycle of the AC power source.

In other embodiments, the microcontroller generates a sequence of large ringing pulses in the second half-cycle of the AC power source. The timing of each ringing pulse in a sequence may be timed in relation to the preceding pulse. For example, the microcontroller may delay the generation of a subsequent ringing pulse for an idle period until the preceding ringing pulse substantially decays. Following this idle period, the periodic software task is repeated and a second or subsequent large ringing pulse is generated. The number of pulses which may be generated during each positive voltage period depends on the inductance, capacitance, resistance, and voltage in the circuit; 4-6 rings are typical.

In an alternative embodiment, the microcontroller may be programmed so that the wait time from when the MOSFET 24 is turned off to when the MOSFET 24 is turned on again in preparation for generating the next ring is shorter than in the preceding embodiment of the invention. As a result of this shorter wait period, the generation of significantly greater number of rings is possible during each positive voltage period. However, each ring is not permitted to substantially decay as it was in the first embodiment. Each of these embodiments has certain desirable characteristics related to the treatment of flowing liquids.

During the negative voltage period, the microcontroller 30 determines if the peak voltage detector 28 has been triggered, which indicates that ringing signal exceeded the reference level set in the voltage reference potentiometer 56. The voltage reference potentiometer 56 can be set to either the minimum or the maximum desired peak voltage level. If the voltage reference potentiometer 56 is set for the minimum peak voltage, and the peak voltage detector 28 has not been triggered, the microcontroller 30 will increase the level of the current reference potentiometer 54 and leave the voltage reference potentiometer 56 at the minimum level. If the voltage reference potentiometer 56 is set for the minimum peak voltage, and the peak voltage detector 28 has been triggered, the microcontroller 30 will hold the level of the current reference potentiometer 54 and change the voltage reference potentiometer 56 to the maximum level. If the voltage reference potentiometer 56 is set to the maximum level, and the peak voltage detector 28 has been triggered, the microcontroller 30 will decrease the level of the current reference potentiometer 54 and leave the voltage reference potentiometer 56 at the maximum level. If the voltage reference potentiometer 56 is set to the maximum level, and the peak voltage detector 28 has not been triggered, the microcontroller 30 will hold the level of the current reference potentiometer 54 and change the voltage reference potentiometer 56 to the minimum level. The preceding actions will move and hold the peak voltage level for the ring pulse between the minimum and maximum desired values. The above logic pattern serves as a digital voltage regulator for the ringing voltage pulse.

Also during the negative voltage period, the microcontroller 30 reads the resistance value of a negative temperature coefficient (NTC) thermistor (not shown) affixed to the heat sink of the SCR 20. If the resistance drops below the value equated to the maximum temperature designated for the SCR heat sink (which is lower than destruction level for the SCR 20) the microcontroller 30 will turn off the SCR and also cease generating ringing pulses. The microcontroller 30 will continue to periodically read the thermistor and when it is determined that the SCR temperature has dropped to a safe level, the microcontroller will automatically resume operation.

In the bottom of the printed circuit board can be two status LEDs (not shown)—preferably one red and one green—viewable through holes in a controller cover. The green LED is lit when the microcontroller 30 has determined that the voltage level of the ringing pulses is within the desired range, otherwise the red LED is lit. A single-pole double-throw relay contact (not shown) is preferably provided for remotely monitoring the status—when the green LED is lit the relay is energized.

The functioning of the above-described SCR-switched circuit is as follows: The SCR (Silicon Controlled Rectifier) acts like a diode with a controllable turn-on capability. When voltage is applied in the “forward direction” (forward-biased-anode positive with respect to cathode) a diode will conduct current. However, the SCR will NOT conduct when forward-biased unless a current is made to flow in its “gate” circuit. If no gate current is applied, the SCR will “block” the flow of current even when forward-biased. Both the SCR and the diode will block the flow of current when the direction of current flow reverses (cathode to anode is the reverse-current direction). The SCR cannot be turned off by removing its gate current after it has been turned on. It can only be turned off by reversing the direction of current flow. In this it acts the same as a silicon diode (rectifier). Hence its name, “silicon controlled rectifier”.

With this as background, a normal cycle of the system proceeds as follows. The coil, transformer and SCR switch are all connected in series. When the time-varying (50 or 60 cycles per second) transformer voltage applies a forward bias to the SCR, gate current is applied and the SCR conducts current through the coil. The SCR has a very low voltage drop from anode to cathode when conducting (less than or equal to one volt typically) so it acts like an almost-perfect switch. On the circuit boards of prior devices MOSFETs (Metal-Oxide-Silicon Field Effect Transistors) are used as the switch, and these MOSFETs have a larger “forward” voltage drop than does an SCR and so dissipate more heat than the SCR. For this reason, in the prior devices ten parallel-connected MOSFETs are used to carry the coil current, where a single SCR will do the same job in devices according to the present invention with lower overall power loss.

When the coil current attempts to reverse direction, the SCR turns off and allows voltage to rise across it, just as a diode would do. The SCR then blocks current flow when the current reverses. Because the voltage and current across the coil are almost 90 degrees out of phase with each other, the current crosses zero (reverses) when there is still substantial voltage across the coil. This frees the coil to “ring” at a low voltage level due to the energy stored in its stray capacitance.

After this initial small or natural “ringing” pulse has died out, a small current is allowed to build up in the coil by closing a MOSFET switch. This switch does not carry the main coil current, so a small switch can be used for this “recharging” function.

When this current has reached a preset level, the MOSFET is turned off, and the coil voltage “rings” again, this time producing a large ringing pulse at a higher voltage level, depending on the amount of current that is allowed to build up.

The regulator circuit measures the peak value of this “ringing” voltage and compares it to the desired value, which is stored as a number in the microprocessor “chip” on the circuit board. If the voltage is too low, then after the ringing pulse has died away the microprocessor turns the MOSFET on again and holds it “on” for a longer time, allowing more coil current to build up than before. The MOSFET is then turned off, and the large ringing pulse repeats.

If the pulse voltage is too high, the microprocessor reduces the “on time” of the MOSFET switch for the next pulse, causing less coil current to build up. The MOSFET then turns off and the ringing voltage is again measured.

When the ringing voltage has reached the desired level (it falls within a “window” range of voltages stored in the microprocessor), the regulator “remembers” this and fixes the MOSFET “on” time for subsequent pulses at this value unless the pulse voltage drifts outside the “window” again. This can occur if the coil resistance changes as the coil temperature changes during operation. If that occurs, preceding steps are repeated until the voltage is once again within the “window”.

All the large “ringing” pulses are generated during the interval when the SCR switch is reverse-biased by the applied circuit voltage from the power transformer. The SCR allows the ringing pulses to occur (its gate current is zero during this interval), even though the ringing pulse voltage will at times cause the SCR voltage to switch over to the “forward” bias condition. The SCR will not turn on when this occurs, unlike a diode, as its gate current is held to zero by the gate driver switch.

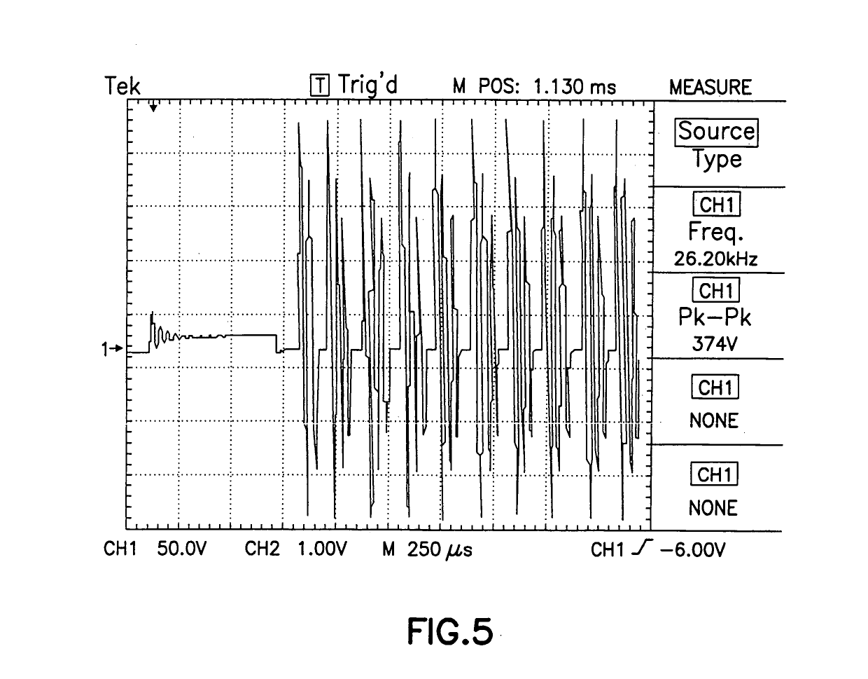

Several large ringing pulses can be inserted in the reverse bias time interval. The number of pulses depends on the desired voltage of the pulse, the inductance of the coil, the capacitance in parallel with the coil (including stray capacitance) and the degree to which each pulse is permitted to decay. In a first embodiment of the invention, each pulse is allowed to substantially (optionally, fully) decay and, all other parameters being equal, fewer pulses are produced. In a second embodiment of the invention, the pulses are not permitted to substantially decay prior to the generation of the next pulse; this allows the generation of a significantly greater number of pulses. The difference between these embodiments may be seen by comparing FIGS. 4 and 5.

Other techniques can be used to generate ringing pulses similar to those described above. The preferred technique, as described above, uses the coil's inductance as an energy storage element to generate the ringing voltage, so it is a simpler method than others which must store the energy elsewhere. However, any device that stores the required pulse energy can be used to generate a ringing pulse. For example, a capacitor can be charged to 150 volts (or any other desired voltage) and switched across the coil during the “off time” of the coil current. This too will generate a ringing pulse, but it requires a high voltage power supply and an extra capacitor. This method also increases the capacitance in the “ringing” circuit, and causes a lower “ringing” frequency than our method does. The preferred method uses the unavoidable “stray” capacitance of the coil as the resonating capacitance, and generates the highest possible ringing frequency.

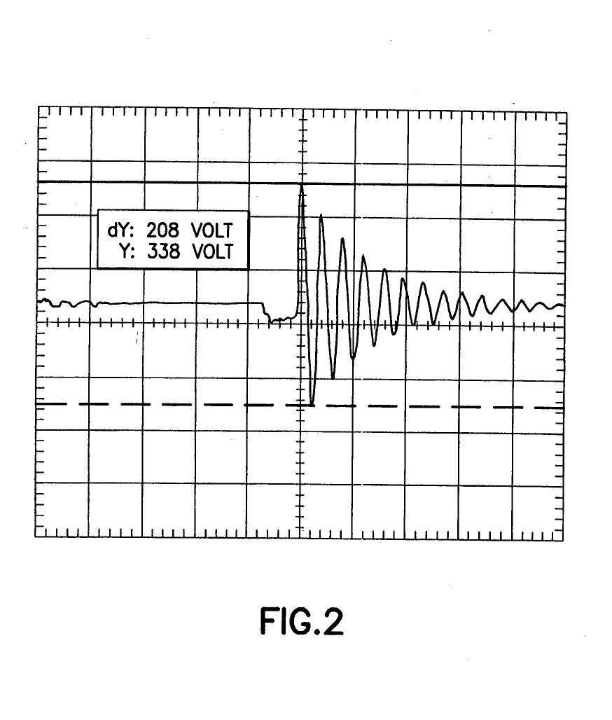

A session testing the performance of a device such as shown by FIG. 1 and as described above with a digital scope on a workbench produced the results shown in FIGS. 2, 3 and 4. As can be seen, the inventive control circuit can fit several (in this case six) large ringing pulses into the available “off” time window between transformer current pulses. The number of large ringing pulses is selectable by inputting a number to the control program via the computer programming interface.

FIG. 2 shows a single pulse from the group; the printing at the left indicates the two horizontal cursor lines were 208 volts apart. The sweep speed is 100 microseconds (μs)/division. The voltage scale is 50V/division.

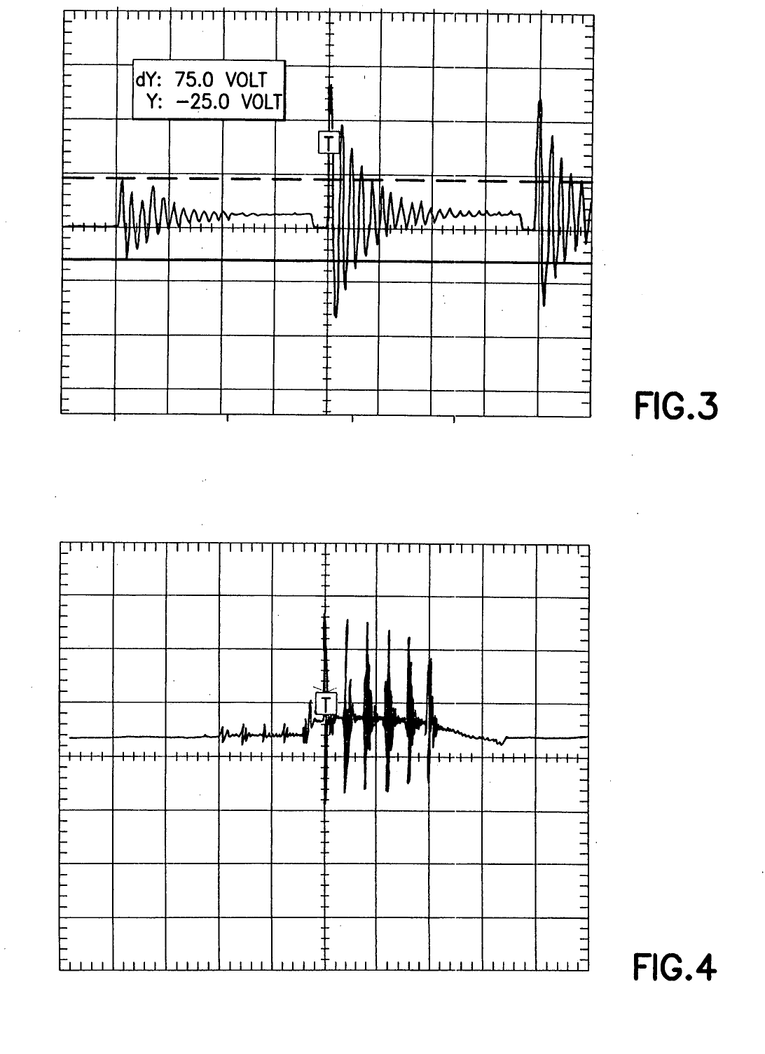

In FIG. 3 is seen the first “natural” ring when the SCR turns off, about 75 volts peak-to-peak, followed by the large rings caused by the control circuit. The large ringing pulses are between three and four times larger in voltage than the small “natural” ringing pulse. More than one large ringing pulse visible in FIG. 3. The sweep speed for this FIG. 3 is 200 μs/division and the voltage scale is 50V/division.

In FIG. 4 we see a full six large ringing pulses. These fit into the approximately 8 millisecond “SCR off” time for this size (one inch) device. With larger coils, this time may be shorter and fewer pulses will fit in. The sweep speed here is 2 ms/division and the voltage scale is 50V/division.

Finally, FIG. 5 shows the result of more than six ringing pulses in an embodiment in which new ringing pulses are initiated before prior pulses decay.

In summary, the apparatus and method embodying the present invention employs an SCR for handling the main coil current and uses a single MOSFET switch to draw a relatively small current through the current coil(s) after the main current pulse has ended. One or more large ringing pulse or pulses is then produced by turning this switch off. Several ringing pulses can be produced in this way during the zero current interval through the coils. The number of pulses which may be generated depends on the characteristics of the system and whether each ring is allowed to substantially decay (first embodiment) or whether subsequent rings are generated prior to substantial decay in the previous ring (second embodiment).

One way to practice this invention is to situate a fluid flow in proximity to the coil assembly while ringing pulses are being generated, for example, by flowing the fluid through the magnetic flux generated by the coil assembly during the ringing pulses. In a particular embodiment, an apparatus embodying the invention may comprise a pipe unit that includes a pipe through which liquid to be treated passes. The pipe may be made of various materials, but as the treatment of the liquid effected by the pipe unit involves the passage of electromagnetic flux through the walls of the pipe and into the liquid passing through the pipe, the pipe is preferably made of a non-electrical conducting material to avoid diminution of the amount of flux reaching the liquid. Other parts of the pipe unit may be contained in or mounted on a generally cylindrical housing surrounding the pipe.

The pipe unit includes one or more electrical coils of a coil assembly as described herein, surrounding the pipe, with an AC power source and control circuitry connected to the coil assembly as described herein. The number, design and arrangement of the coils making up the coil assembly may vary. In illustrative embodiments, the coil has four coil sections arranged in a fashion similar to that of U.S. Pat. No. 5,702,600 and U.S. Pat. No. 6,063,267, the disclosures of which are incorporated herein by reference. The coils are associated with different longitudinal sections of the pipe. That is, a first coil section is wound onto and along a bobbin and in turn extending along a first pipe section, a second coil section is wound on and along another bobbin itself extending along the a second pipe section, and third and forth coil sections are wound on a third bobbin itself extending along a third pipe section, with the third coil section being wound on top of the forth coil section. The winding of the third and forth coil sections on top of one another, or otherwise in close association with one another, produces a winding capacitance between those two coils which forms all or part of the capacitance of a series resonant circuit in a coil assembly as described herein. Alternatively, the coils may be wound around the pipe, without the use of a bobbin.

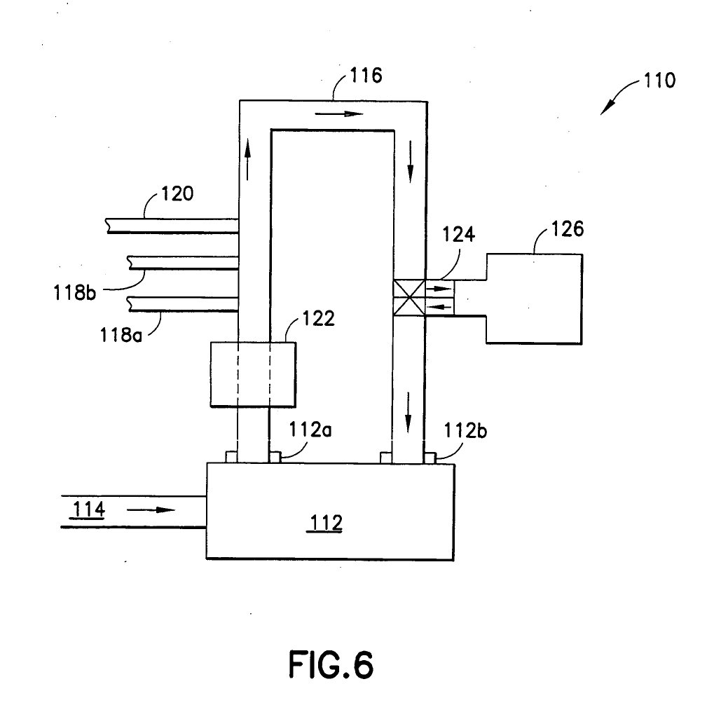

An illustrative embodiment of the use of such a power pulse system in a potable hot water system is shown in FIG. 6 as system 110, which includes the water heater 112 connected to a water supply line 114, a recirculation loop 116 connected to the water heater 112, and various branch lines 118a, 118b, etc., to sinks and showers and other end-user devices, and to one or more “dead legs” 120. The system 110 includes a pulsed power water treatment apparatus 122 installed in the recirculation loop 114 adjacent an outlet 112a from the water heater. (In an alternative embodiment, the pulsed power water treatment apparatus 122 may be installed at another position in the recirculating loop, e.g., adjacent the return inlet 112b to the water heater.) The loop 116 includes a tap 124 that allows water flowing in the loop to be temporarily diverted to an external loop for chemical treatment or for other purposes. To initiate treatment of the water in the system, a chlorine dioxide generator 126 is tapped into to the system via a tap 124. Preferably, chlorine dioxide generator 126 is a portable generator facility.

Preferably, an initial use of the purification system according to this invention comprises the use of both the pulsed power apparatus and chemical treatment to assure that any previously existing biofilm is destroyed and/or and bacteria resident in the system are promptly killed. For this purpose, the water is diverted by tap 124 to the chlorine dioxide generator 126, and the chlorine dioxide generator 126 and the pulsed power water treatment apparatus 122 are both activated, preferably simultaneously. The chlorine dioxide generator 126 is allowed to run until evidence of a biofilm is substantially eliminated; then, the chlorine dioxide generator 126 is turned off and, optionally, disconnected from the water system. The pulsed power water treatment apparatus 122 operates after the chlorine dioxide generator 126 is turned off, to continue treating the water.

The chlorine dioxide generator 126 may be re-connected (if necessary) and activated again when needed, e.g., should the biofilm become re-constituted, or at prescribed intervals. During these treatments the pulsed power water treatment apparatus 22 may continue to operate; the chlorine dioxide generator 126 is connected to the system and is activated for an interval sufficient to reduce or eliminate evidence of a biofilm. The chlorine dioxide generator 126 is then de-activated and, optionally, disconnected from the system. The pulsed power water treatment apparatus 122 continues to operate. The chlorine dioxide generator 126 can be re-attached to the system on a pre-scheduled periodic basis or on an as-needed basis in response to evidence of the re-establishment of a biofilm and/or a rise in the number of bacteria in the water.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A method for treating a flow of water in a recirculating potable hot water system, the method comprising:
subjecting the flow to a combination of electromagnetic pulses and chemical treatment.

2. The method of claim 1, comprising applying the chemical treatment simultaneously with the electromagnetic pulses, and then applying the electromagnetic pulses without the chemical treatment.

3. The method of claim 1, wherein the chemical treatment comprise treating the water with chlorine dioxide.

4. The method of claim 1, wherein the method is effective for the amelioration of Legionella bacteria in the water.

5. The method of claim 1, comprising applying water chemical treatment on a periodic basis.

6. The method of claim 1, wherein the water system is a potable water system.

7. The method of claim 2, wherein the chemical treatment is effective for the substantial removal of biofilm in the water system.

8. The method of claim 7, comprising testing the water for biofilm and stopping the water treatment once the water is substantially free of a biofilm.

9. In a circulating potable hot water system comprising a water heater and a circulation line providing a flow loop for water to and from the water heater and a tap for diverting circulating water through an external flow loop, the improvement comprising a pulsed power water treatment apparatus mounted on the circulation line.
